(19) United States
(12) Patent Application Publication
(10) Pub. No.: US 2017/0273871 A1
(43) Pub. Date: Sep. 28, 2017

(54) SORTING PILLBOX

(71) Applicants: Eleanor Glazer, Santa Barbara, CA (US); Ivor Miskulin, Santa Barbara, CA (US)

(72) Inventors: Eleanor Glazer, Santa Barbara, CA (US); Ivor Miskulin, Santa Barbara, CA (US)

(21) Appl. No.: 15/506,490

(22) PCT Filed: Sep. 18, 2015
(86) PCT No.: PCT/US15/50888

§ 371 Date: Feb. 24, 2017

Related U.S. Application Data
(60) Provisional application No. 62/052,333, filed on Sep. 18, 2014.

(51) Int. Cl. A61J 7/04; A61J 7/00; G06F 19/00; B65D 25/54; B65D 43/16; A61J 1/03; B65D 25/20

(52) U.S. Cl. CPC A61J 7/04; A61J 1/03; A61J 7/0084; B65D 25/20; B65D 25/54; B65D 43/161; G06F 19/3462

(57) ABSTRACT

The present invention provides a modular dispenser for organizing solid dosage preparations. An innovative lid concept provides a space to layout and inspect an incremental count of solid dosage preparations preliminary to committing them to compartment storage with minimal manipulative effort. Mnemonic devices, such as indicia, color-coded lids, and a mobile device app facilitate remembering event times. Releasable mounting and modular construction facilitates the staging of individual compartments for travel and sequencing purposes.

### CROSS-REFERENCE TO RELATED APPLICATIONS

This is a national stage application claiming priority under 35 USC 371 to PCT/US2015/050888, filed 18 Sep. 2015, and to U.S. Provisional Application 62/052,333, filed 18 Sep. 2014, both of which are incorporated herein by reference in entirety.

### FIELD OF THE INVENTION

This invention relates to pill dispensing containers, and more particularly to mnemonic devices for medication regimens.

### BACKGROUND OF THE INVENTION

The problem of complying with a physician-prescribed medication regimen is exacerbated by the demographic of an aging population prevalent in the developed world. According to governmental sources, there are over 43 million adults aged 65 and over in the U.S. alone, and this number is forecasted to almost double by the year 2040. Nearly 92% of seniors have at least one chronic condition, and 77% have at least two. More than half take 5 different prescription drugs regularly, and one in four take between 10 and 19 pills a day. Add to this count vitamins, supplements, NSAID's and other non-prescription medications increasingly prevalent in what has become, in recent years, a “pill culture”, and the task of keeping track of doses and times of administration becomes even more unmanageable. Seniors are especially at risk for managing multiple regimens due, not only to the physiological changes attendant to aging, but to higher incidence of chronic diseases and conditions.

Pill boxes that array daily doses in modular-like compartments are useful for keeping track of regimen schedules. Most are labeled with day-of-the-week indicia and some also have additional compartments for iterative applications during a day, such as for morning (AM) and evening (PM). Typically, the compartments are connected in a box representing a week of administration. The need for enlargement of the individual compartments to accommodate the increasing volume of pills, however, makes the overall size unwieldy for travel purposes. At the same time, the limitations on dexterity prevalent with seniors make it difficult to load the compartments by hand, and errors of manipulation, such as separating individual pills, abound. Correcting a misplacement of a pill, or even inspecting the contents of a compartment, requires dumping a load and starting over.

What is needed is a senior-friendly mnemonic device that allows the pill-taker to pre-sort the regimen and visually confirm it before loading the compartments of a pill box. Another need is to separate the individual compartments for selection purposes while providing an organization means to keep track of each day's administration.

### SUMMARY OF THE INVENTION

The present invention beneficially fulfills these needs by providing individual daily containers magnetically held onto a base from which they can be selectively removed and repositioned at will. One or several of the containers can be removed to make up a kit for short-term travel, or the base can be eliminated to further conserve space. The individual containers are capped with an elastomeric cover containing a receptacle for assembling and sorting a daily regimen of doses. The receptacle facilitates a visual confirmation before committing the pills to the container through an expandable aperture therein. In the case of AM and PM accommodation, a two-compartment container can be capped with piggybacked covers of different colors, or markers, to facilitate visual identification. The container can be switched around on the base following a current administration of pills to indicate, at a visual glance, the next administration due. The reminder function of the device can be augmented by adding a mobile device app in a system of apparatus plus media tool.

Accordingly, it is an object of the present invention to provide a weekly complement of daily pillbox containers releasably organized on a base. It is a further object to connect the containers to the base by magnetic means and array them there upon by post and recess means. It is a further object to identify the containers, and compartment divisions therein, by indicia means. It is a further object to provide a container cover having a concavity therein for the purpose of sorting and displaying a daily regimen of pills. It is a further object to provide a means for dispensing the pills from the concavity directly into the container after a confirming inspection of the pills. It is a further object to provide a visual means of identifying compartments within the container by hingeably attached lids of different colors. It is a further object to provide access with minimal force of manipulation. It is a further object to accommodate outsized multivitamins and supplements. It is a further object to visually inspect stored pills in the container without removing them. It is a further object to provide a mobile device app to signally communicate a time for dose administration.

These objects, and others to become hereinafter apparent, are embodied in a modular dispenser for organizing medicaments, comprising, in a first element, at least one modular container having at least one compartment. The at least one compartment has a top, a front wall and a back wall. The front wall has indicia thereon. A second element comprises an elastomeric lid attached proximate the back wall to hingeably cover the top. The elastomeric lid has a concave recess therein configured to receive the medicaments. The concave recess has at least one slit there through. A final element comprises a base mount configured to releasably receive and register the at least one modular container. With such means and in such manner, the medicaments may be distributed from supply to the concave recess for visual count and confirmation before being pushed through the at least one slit into the at least one compartment for storage therein until retrieved therefrom by hingeably opening the lid at a time indicated by the indicia.

In a preferred embodiment, the at least one modular container is seven containers and each corresponds to a day of the week indicated by the indicia. The at least one compartment is two compartments and each corresponds to AM or PM as indicated by the color of the elastomeric lid. The two compartments are joined proximate the back walls thereof and the elastomeric lids are joined by living hinge construction. The at least one slit is two slits in cruciate formation. Finally, each modular container is releasably mounted to the base by magnetic means.

In an alternate embodiment, a modular dispenser system comprises a reminder app for a mobile device in combination with the elements and functionalities of the modular dispenser as described above.

As this is not intended to be an exhaustive recitation, other embodiments may be learned from practicing the invention or may otherwise become apparent to those skilled in the art.

### DESCRIPTION OF THE DRAWINGS

Various other objects, features and attendant advantages of the present invention will become fully appreciated as the same becomes better understood through the accompanying drawings and the following detailed description, in which like reference characters designate the same or similar parts throughout the several views, and wherein:

FIG. 1 is a perspective view of the modular dispenser of the present invention;

FIG. 2 is an exploded perspective view of one of the several of the containers of the modular dispenser in array;

FIG. 3 is a perspective view of one transparent module showing two compartments;

FIG. 4 is a top plan view of one module;

FIG. 5 is a section view of the module of FIG. 4 taken along the lines 5-5;

FIG. 6 is a top plan view of the modular dispenser showing bi-colored lids and staging of the containers for event sequencing;

FIG. 7 is an exploded perspective view of a preferred module;

FIG. 8 is a top plan view of the preferred module; and

FIG. 9 is section view of the preferred module of FIG. 8 taken along the lines 9-9.

### DETAILED DESCRIPTION OF THE PREFERRED EMBODIMENT

Throughout the description and the claims, the term “pill” will be taken to refer to a tablet, a capsule or any solid dosage preparation, medical or otherwise.

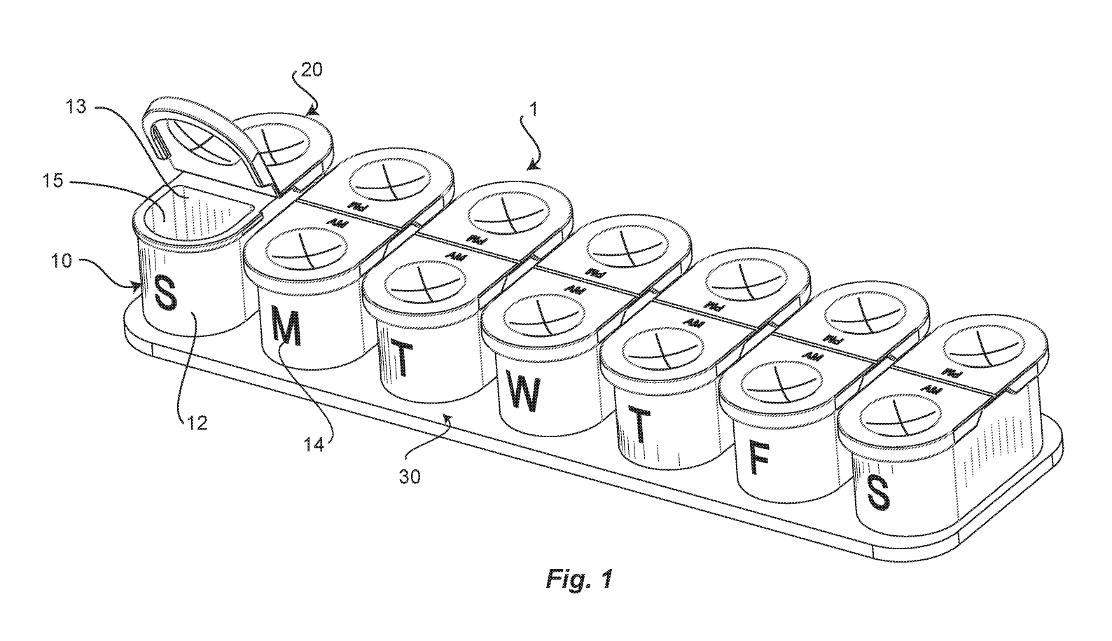

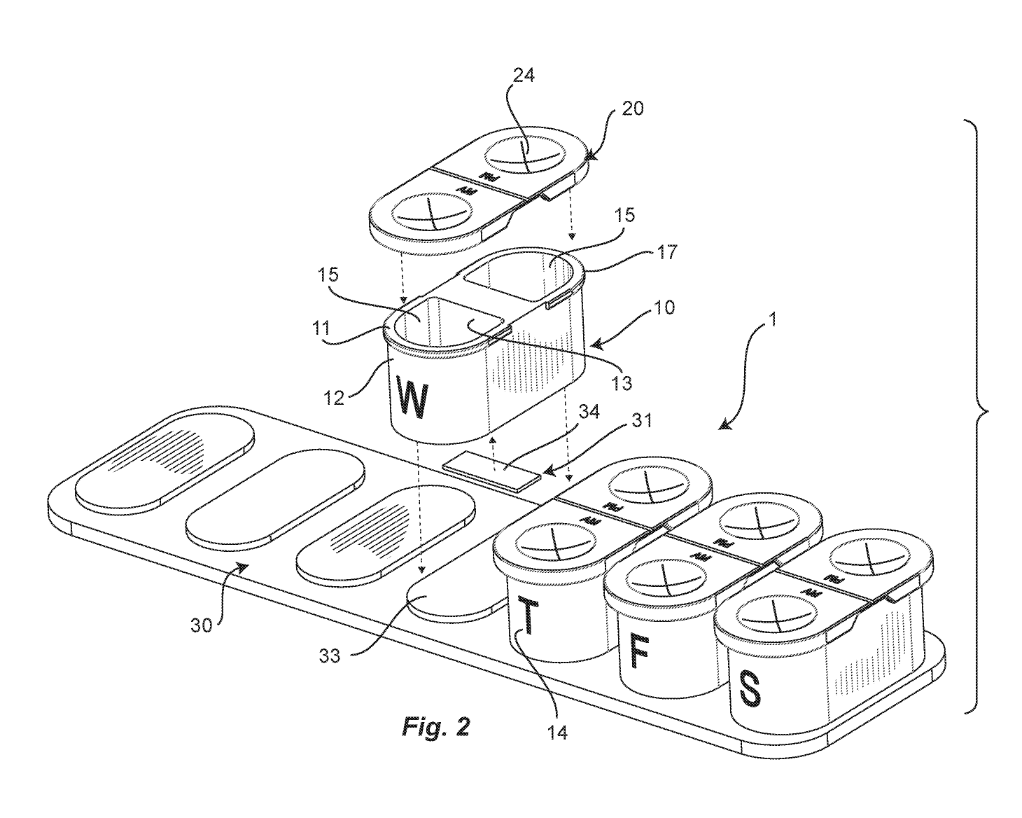

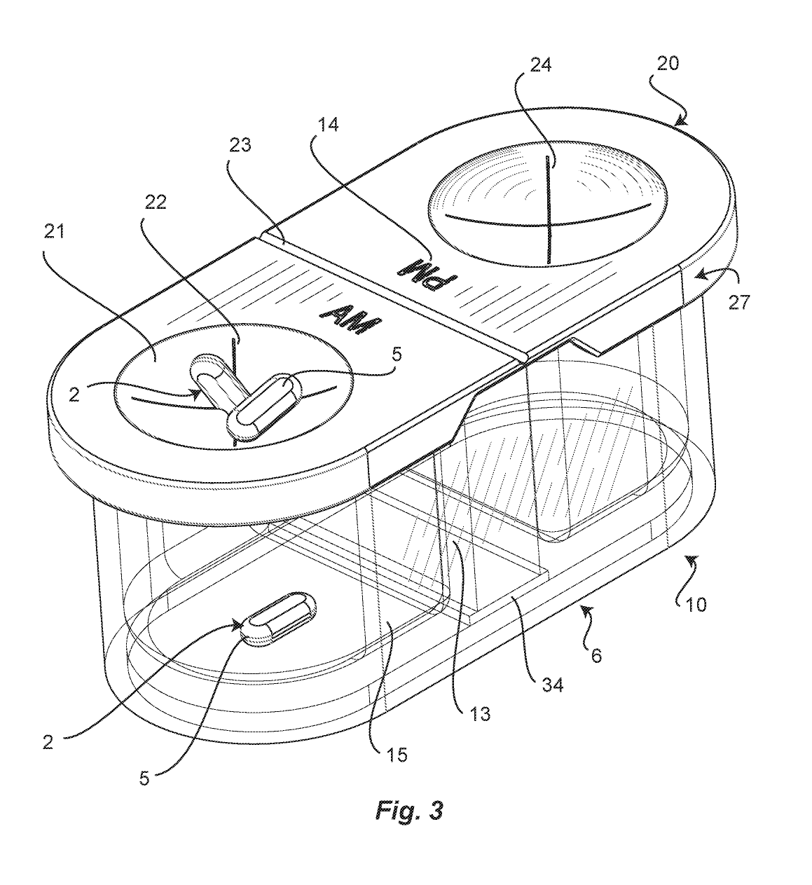

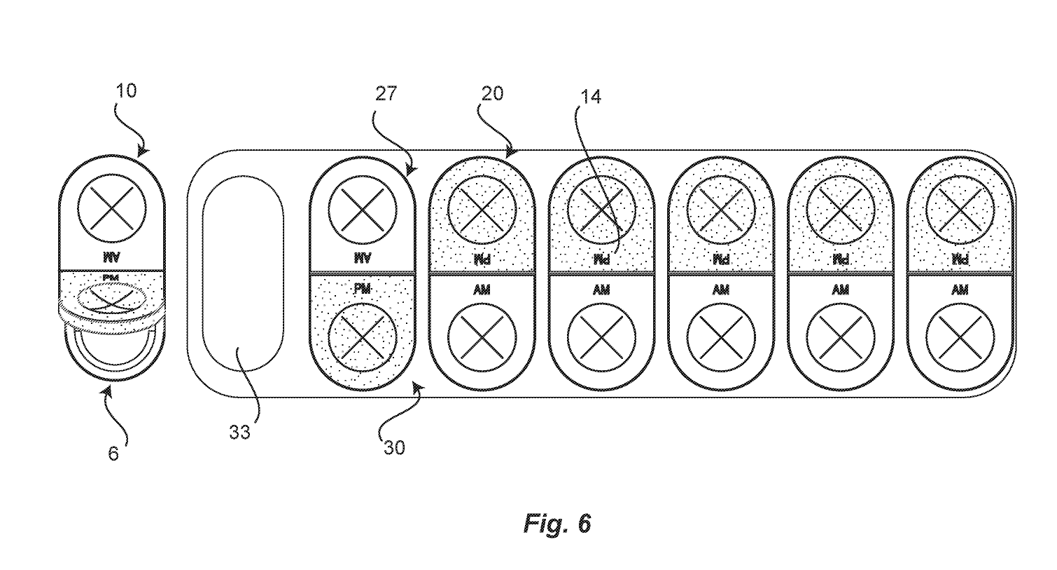

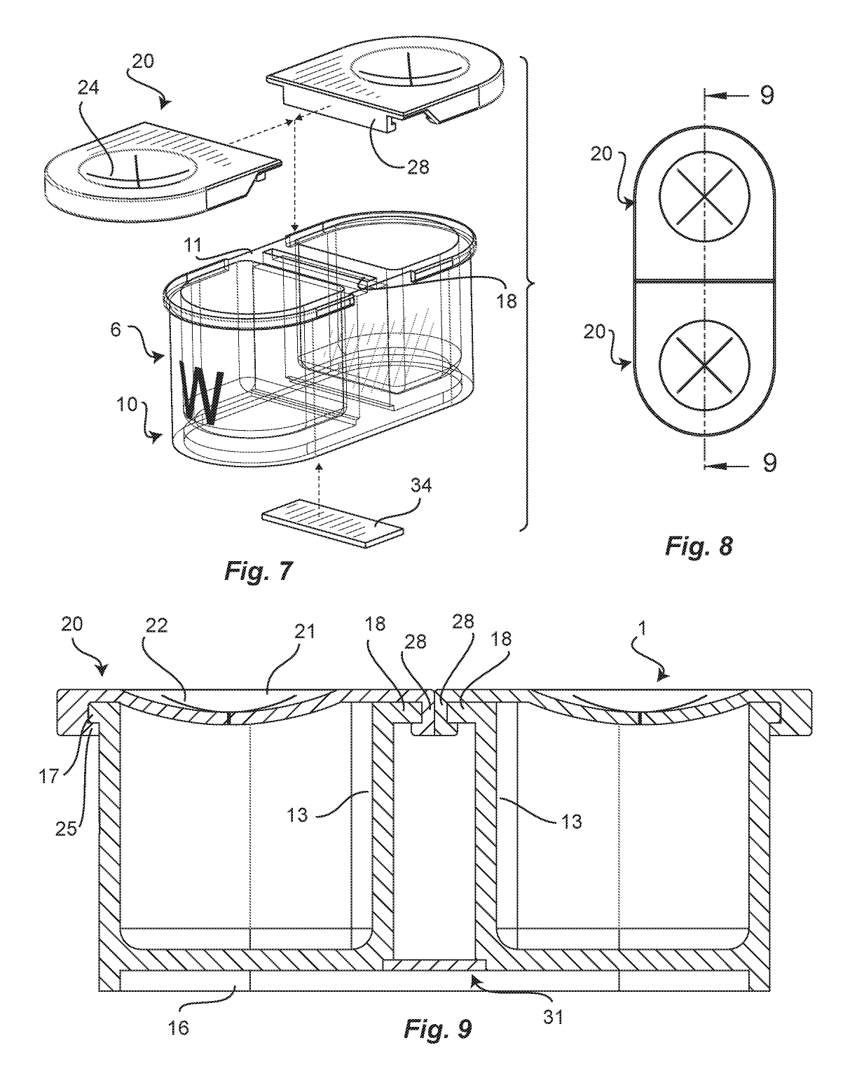

Referring to FIGS. 1 and 2, a modular dispenser 1 for organizing medicaments 2 (FIG. 3) comprises an at least one modular container 10. The modular container 10 has at least one compartment 15 therein. The at least one compartment 15 has a top 11, a front wall 12 and back wall 13. The front wall 12 has indicia 14 thereon to identify the container 10 with a particular time of administration. In the preferred embodiment, the indicia indicates a day-of-the-week, typically displayed by one or more initials of the day. Preferably, the at least one modular container 10 numbers seven containers and the at least one compartment 15 numbers two compartments. The two compartments 15 may be associated with AM and PM administrations of the medicaments 2. Preferably, the modular container 10 is transparent so that contents placed therein can be easily viewed and inspected (FIGS. 3 and 7).

In the preferred embodiment, the medicaments 2 are pills 5 of a nominal 8-10 mm size. Each compartment 15 is configured to receive a first preferred count of between 10 and 19 pills 5. Ideally, the volume of the compartment 15 is sufficient to include at least one outsized multivitamin or supplement. In a particularity, the compartment 15 is approximately 10 cm³ in volume. The pills 5 may include tablets, capsules, caplets, gelcaps or any combination thereof.

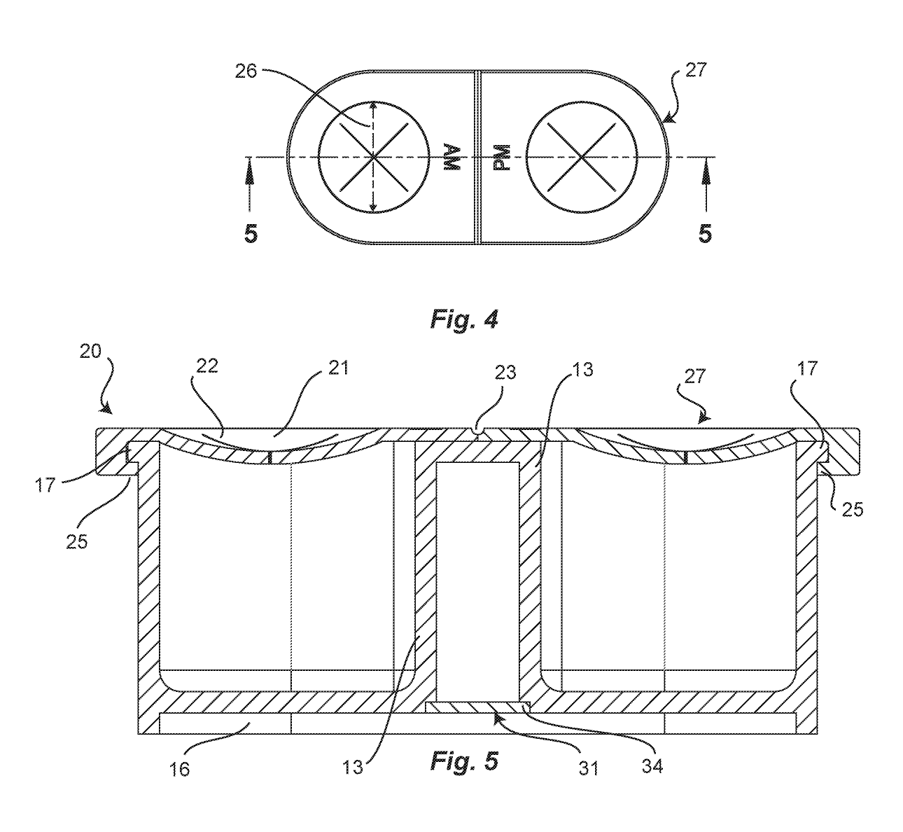

As shown in FIGS. 3-5, 7 and 9, the modular dispenser 1 further comprises an elastomeric lid 20 hingeably attached to a corresponding compartment 15 proximate the back wall 13 thereof. A lidded modular container 10 comprises a module 6. The elastomeric lid 20 covers the top 11 of the compartment 15 to protect and isolate the contents placed inside. The elastomeric lid 20 has a concave recess 21 debossed therein to receive the medicaments 2 for counting and inspection purposes. Consequently, the concave recess 21 is preferably configured to a second preferred count of medicaments 2. In the preferred embodiment, the second preferred count is between 2 and 7 pills 5. In a particularity, a span diameter 26 (FIG. 4) of the concave recess 21 is approximately 2.5 cm.

The concave recess 21 has at least one slit 22 there through to provide an opening in the elastomeric lid 20 for dispensing the medicaments 2 into the compartment 15 of the modular container 10. In the preferred embodiment, there are two slits 22 in crossed, or cruciate, formation 24. The crossed slits provide tongue-like appendages of the elastomeric lid 20, which are easily deformed into an aperture by gentle pressure applied to the medicaments 2 from above. The crossed slits 22 facilitate dispensing the medicaments into storage in the compartment 15 after the inspecting and counting step.

As best shown in FIG. 2, the modular dispenser 1 further comprises a base mount 30. The base mount 30 comprises a plurality of protuberances 33 matching the plurality of the modular containers 10. Each modular containers 10 has a mating recess 16 (FIG. 5) to locate to a corresponding protuberance 33 by interposition therewith. In the preferred embodiment, the protuberances 33 are arrayed linearly and spaced to register the modular containers side by side for convenient viewing of the indicia.

The modular containers 10 may be releasably mounted to the base mount 30 by magnetic means 31. In the preferred embodiment, the magnetic means 31 comprises at least one magnet 32 (not shown) embedded in one of either of the recess 16 or the protuberance 33 and a ferromagnetic plate 34 embedded in the other. In the preferred embodiment, the ferromagnetic plate 34 is comprised of steel. The symmetries of the protuberances 33 and the recesses 16 are such that the modular containers 10 may be dismounted and switched end for end in a remount. This switching is useful for visually indicating progress of administration events, as further discussed below.

In the preferred embodiment, as best shown in FIGS. 5 and 7, the two compartments 15 are arranged back-to-back. The two corresponding elastomeric lids 20 are similarly arranged back-to-back. Each elastomeric lid 20 has a hinge hook 28, which extends around and under a ledge 18 extending from the back wall 13 of the corresponding compartment 15 to anchor the elastomeric lid 20 (FIGS. 7 and 9). In an alternate embodiment, two corresponding elastomeric lids 20 are joined at a living hinge 23 to form a dual lid composite 27 (FIGS. 3 and 5).

As best shown in FIGS. 5 and 9, each compartment 15 has a periphery lip 17 protruding from at least the front wall 12. Each elastomeric lid 20 has an engagement flange 25 positioned to underlap the periphery lip 17 of a corresponding compartment 15. Because of resiliency of the elastomeric lid 20, the underlapped engagement can be peeled away when the lid is raised and hinged open to reveal the compartment. In the case of the dual lid composite 27, while one of the lids 20 is open, the other remains engaged to provide a pivot base for the living hinge 23. Because the elastomeric lids 20 are malleable, opening and closing the compartments for purposes of dispensing the contents therein and, and afterward resealing them, can be done with minimal manipulative effort.

The dual lid composite 27 can be labeled with indicia to indicate AM and PM for the constituent compartments 15. In the preferred embodiment, there are two lid colors to differentiate AM compartments from PM compartments. In a particularity, the two colors are white for AM and black for PM. In another particularity, the two colors are green and blue. The colors may be any two colors showing contrast. As illustrated in FIG. 6, where a second color is indicated by stippling, the containers 10 can be staged and oriented to broadcast, at a glance, the next compartment to be emptied. In this case, it is visually evident that the next administration event occurs at Monday PM.

The modular dispenser 1 may be injection molded from any food grade and BPA-free resins. Preferably, the resin of choice is clear polycarbonate (PC) or crystal styrene (PS). The base mount 30 may be injected molded from any tough commodity resin, such acrylonitrile butadiene styrene (ABS), high-impact polystyrene (HIPS) or high-density polyethylene (HDPE), for example. The elastomeric lid 20 may compression molded from butyl rubber or injection molded from a thermoplastic elastomer (TPE), for example. Preferably, the resin of choice is a thermoplastic urethane (TPU). A bi-colored dual lid composite 27 may be two-shot injection molded. The living hinge 23 may be formed in-mold and molecularly oriented by known technologies.

In an alternate embodiment, a modular dispenser system (not shown) is comprised of a mobile device app (not shown) in combination with the modular dispenser 1 discussed above. The mobile device app is a downloaded software application that operates to signal an alert through its host mobile device at a selected reminder interval to take the next administration of pills. The app may have a customization feature to record data pertaining to a patient's list of medications, for example. The combination of the mobile device app and the improved ease-of-use features and other mnemonic functionalities provided by the innovative modular dispenser herein disclosed assures critical patient compliance with regard to one or many medication regimens.

It is to be understood that the invention is not limited in its application to the details of construction and to the arrangements of the components set forth in the preceding description or illustrated in the drawings. For example, the modular container 10 may be mounted to the base mount 30 by hook-and-loop means, commonly known by the trade name Velcro®. Also, it is to be understood that the phraseology and terminology employed herein are for the purpose of the description and should not be regarded as limiting.

1. A modular dispenser for organizing medicaments, comprising:
at least one modular container having at least one compartment, the at least one compartment having a top, a front wall and a back wall, the front wall having indicia thereon;
an elastomeric lid attached proximate the back wall to hingeably cover the top, the elastomeric lid having a concave recess therein configured to receive the medicaments, the concave recess having at least one slit there through; and
a base mount configured to removeably receive and selectively reposition the at least one modular container to indicate a next administration event;
whereby, the medicaments may be distributed from supply to the concave recess for visual count and confirmation before being pushed through the at least one slit into the at least one compartment for storage therein until retrieved therefrom by hingeably opening the lid at a time indicated by the indicia.

2. The modular dispenser of claim 1, wherein the at least one modular container numbers seven and each corresponds to a day of a week indicated by the indicia.

3. The modular dispenser of claim 2, wherein the at least one compartment numbers two and each corresponds to AM or PM as indicated by a color of the elastomeric lids.

4. The modular dispenser of claim 3, wherein the two compartments and the two elastomeric lids are arranged back-to-back.

5. The modular dispenser of claim 4, wherein the elastomeric lids are joined by living hinge construction.

6. The modular dispenser of claim 1, wherein the medicaments are one or more of pills, capsules, caplets, gelcaps or any combination thereof.

7. The modular dispenser of claim 1, wherein the at least one compartment is configured to receive a first preferred number of medicaments of nominal size.

8. The modular dispenser of claim 7, wherein the first preferred number is in the range of 10-19.

9. The modular dispenser of claim 1, wherein the concave recess is configured to receive a second preferred number of medicaments arrayed in a manner to facilitate counting.

10. The modular dispenser of claim 9, wherein the second preferred number is in the range of 2-7.

11. The modular dispenser of claim 1, wherein the at least one slit numbers two in cruciate formation.

12. The modular dispenser of claim 3, wherein each modular container is releasably mounted to the base by magnetic means.

13. The modular dispenser of claim 3, wherein each modular container is registered in position on the base by means of a base protuberance interpositioned with a corresponding recess in the container.

14. The modular dispenser of claim 13, wherein the magnetic means is a ferromagnetic plate embedded in the recess and a magnet embedded in the base protuberance.

15. The modular dispenser of claim 13, wherein the magnetic means is a ferromagnetic plate embedded in the base protuberance and a magnet embedded in the recess.

16. The modular dispenser of claim 13, wherein the protuberance and recess permit, by symmetry means, a 180 degree rotation of the modular container after each dispensation of compartment contents, the rotation indicating by position the next administration event.

17. The modular dispenser of claim 1, wherein the at least one modular container is transparent to allow visual inspection of the contents therein.

18. The modular container of claim 1, wherein at least the front wall further comprises a lip and the elastomeric lid further comprises a corresponding engagement flange to secure the compartment by underlap and releaseably open it by resiliently by-passing the lip.

19. A modular dispenser system for organizing medicaments, comprising:
at least one modular container having at least one compartment, the at least one compartment having a top, a front wall and a back wall, the front wall having indicia thereon;
an elastomeric lid attached proximate the back wall to hingeably cover the top, the elastomeric lid having a concave recess therein configured to receive the medicaments, the concave recess having at least one slit there through;
a base mount configured to releasably receive and selectively reposition the at least one modular container to indicate a next administration event; and
a reminder app for a mobile device;
whereby, at prompting by the reminder app, the medicaments may be distributed from supply to the concave recess for visual count and confirmation before being pushed through the at least one slit into the at least one compartment for storage therein until retrieved therefrom by hingeably opening the lid at a time indicated by the indicia.

20. The modular dispenser system of claim 19, wherein the at least one modular container numbers seven and each corresponds to a day of a week indicated by the indicia.

21. The modular dispenser system of claim 20, wherein the at least one compartment numbers two and each corresponds to AM or PM as indicated by a color of the elastomeric lid.
